(19) United States
(12) Patent Application Publication
(10) Pub. No.: US 2022/0380228 A1
(43) Pub. Date: Dec. 1, 2022

(54) PROCESS

(71) Applicant: JOHNSON MATTHEY PUBLIC LIMITED COMPANY, London (GB)

(72) Inventors: Daniel CAIRNS, Billingham, Cleveland (GB); Andrew DIAMOND, Billingham, Cleveland (GB)

(21) Appl. No.: 17/754,088

(22) PCT Filed: Sep. 22, 2020
(86) PCT No.: PCT/GB2020/052284

§ 371 Date: Mar. 23, 2022

(30) Foreign Application Priority Data
Sep. 25, 2019 (GB) 1913817.1

(51) Int. Cl. C01G 53/00

(52) U.S. Cl. CPC C01G 53/42; C01P 2002/72; C01P 2004/04; C01P 2004/61

(57) ABSTRACT

A process for producing a surface-modified particulate lithium nickel metal oxide material is provided. The process comprises the addition of a controlled quantity of a coating liquid to lithium nickel metal oxide particles followed by a calcination step.

### FIELD OF THE INVENTION

The present invention relates to improved processes for making lithium nickel metal oxide materials which have utility as cathode materials in secondary lithium-ion batteries.

### BACKGROUND OF THE INVENTION

Lithium nickel metal oxide materials having a layered structure find utility as cathode materials in secondary lithium-ion batteries. Varying amounts of the nickel in such materials may be substituted with other metals to improve electrochemical stability and cycling performance. It has also been found that increasing or enriching the amount of certain metal elements at the particle surface or, in the case of secondary particles, at the grain boundary between adjacent primary particles, can be an effective way to improve electrochemical performance.

Typically, grain boundary enrichment is achieved by immersion of secondary particles of the lithium nickel metal oxide material in a solution of one of more metal-containing compounds and then removal of the solvent through evaporation, followed by a subsequent heat treatment or calcination step.

For example, WO2013025328 describes a particle including a plurality of crystallites including a lithium nickel metal oxide composition having a layered α-NaFeO₂-type structure, and a grain boundary between adjacent crystallites, wherein a concentration of cobalt in the grain boundaries is greater than in the crystallites. Example 2 of WO2013025328 has the composition Li_{1.01}Mg_{0.024}Ni_{0.88}Co_{0.12}O_{2.03} and has cobalt-enriched grain boundaries. In order to achieve enrichment of the grain boundaries, secondary particles of a lithium nickel metal oxide material are added to an aqueous solution of lithium nitrate and cobalt nitrate and the resulting slurry subsequently spray dried before a heat treatment step.

The use of surface modification and/or grain boundary enrichment has the drawback that additional process steps are required, leading to higher energy consumption, increased levels of process waste, and higher manufacturing costs. This can impact on the commercial viability of such materials and have environmental impacts. There remains a need for improved processes for the manufacture of lithium nickel metal oxide materials. In particular, there remains a need for improvements in processes which lead to surface modification and/or grain boundary enrichment.

### SUMMARY OF THE INVENTION

The present inventors have surprisingly found that immersion of lithium nickel metal oxide particles in a solution of one or more metal-containing compounds is not required to achieve grain boundary enrichment, and that the addition of a controlled volume of a coating liquid to secondary particles of lithium nickel metal oxide materials can be used to modify the composition at the grain boundaries without the requirement for significant solvent evaporation. It has further been found that the electrochemical performance of materials produced by immersion-evaporation methods may be at least matched by materials produced by the herein described process, with the advantage that a spray-drying or an alternative evaporation step is not required during the manufacturing process, significantly reducing energy consumption and industrial waste.

Accordingly, in a first aspect of the invention there is provided a process for producing a surface-modified particulate lithium nickel metal oxide material having a composition according to Formula 1:

LiₐNiₓM_{y}A_{z}O_{2+b} Formula 1
in which:
M is one or more of Co and Mn;
A is one or more of Al, V, Ti, B, Zr, Cu, Sn, Cr, Fe, Ga, Si, Zn, Mg, Sr, and Ca
0.8≤a≤1.2
0.5≤x≤1
0<y≤0.5
0≤z≤0.2
−0.2≤b≤0.2
x+y+z=1
the process comprising the steps of:
(i) providing lithium nickel metal oxide particles in the form of secondary particles comprising a plurality of primary particles;
(ii) providing a coating liquid at a temperature of at least 50° C., the coating liquid comprising at least one metal-containing compound;
(iii) adding the coating liquid to the lithium nickel metal oxide particles to form an impregnated powder, the volume of coating liquid added corresponding to 50 to 150% of the apparent pore volume of the lithium nickel metal oxide particles;
(iii) calcining the impregnated powder to form the surface-modified particulate lithium nickel metal oxide material.

In a second aspect, of the invention there is provided a surface-modified particulate lithium nickel metal oxide obtained or obtainable by a process described herein.

### BRIEF DESCRIPTION OF THE DRAWINGS

FIG. 1 shows an x-ray diffraction (XRD) pattern of material produced according to Example 3 and an immersion-spray dried comparison.

FIG. 2 shows the results of electrochemical testing of surface-modified lithium nickel metal oxides produced by experimental runs 1 to 3 and an immersion-spray dried comparison.

FIG. 3 shows the results of cycle life testing of surface-modified lithium nickel metal oxides produced by experimental runs 1 to 3 and an immersion-spray dried comparison.

FIG. 4 shows the results of electrochemical testing of surface-modified lithium nickel metal oxides produced by experimental run 4 and run 5 and an immersion-spray dried comparison.

FIG. 5 shows the results of cycle life testing of surface-modified lithium nickel metal oxides produced by experimental run 4 and run 5 and an immersion-spray dried comparison.

FIG. 6 shows the results of electrochemical testing of a lithium nickel manganese cobalt oxide (NMC) base material and a surface-modified NMC material produced in Example 7.

FIG. 7 shows the results of cycle life testing of an NMC base material and a surface-modified NMC material produced in Example 7.

FIG. 8 shows Focussed Ion Beam-Transmission Electron Microscope (FIB-TEM) images of material produced according to the method of experimental run 4.

FIG. 9 shows FIB-TEM images of material produced according to the method of experimental run 5.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The present invention provides a process for the production of surface-modified particulate lithium nickel metal oxide materials having a composition according to Formula I as defined above.

In Formula I, 0.8≤a≤1.2. It may be preferred that a is greater than or equal to 0.9, or 0.95. It may be preferred that a is less than or equal to 1.1, or less than or equal to 1.05. It may be preferred that 0.90≤a≤1.10, for example 0.95≤a≤1.05, or that a =1 or about 1.

In Formula I, 0.5≤x<1. It may be preferred that 0.6≤x<1,for example that 0.7≤x<b1, 0.75≤x<1, 0.8x<1, 0.85≤x <1or 0.9≤x<1. It may be preferred that x is less than or equal to 0.99, 0.98, 0.97, 0.96 or 0.95.It may be preferred that 0.75≤x<1, for example 0.75≤x≤, 0.99, 0.75≤x≤0.98, 0.75≤x≤0.97, 0.75≤x 0.96 or 0.75≤x≤0.95. It may be further preferred that 0.8≤x<1,for example 0.8≤x≤0.99, 0.8≤x≤0.98, 0.8≤x≤0.97, 0.8≤x≤0.96 or 0.8≤x≤0.95. It may also be preferred that 0.85≤x<1,<for example 0.85≤x≤0.99, 0.85≤x≤0.98, 0.85≤x≤0.97, 0.85≤x ≤0.96 or 0.85≤x≤0.95.

M is one or more of Co and Mn. In other words, the general formula may alternatively be written as LiₐNiₓCo_{y1}Mn_{y2}A_{z}O_{2+b} wherein y1+y2 satisfies 0<y1+y2≤0.5, wherein either y1 or y2 may be 0. It may be preferred that M is Co alone, i.e. the surface-modified lithium nickel metal oxide contains no Mn.

In Formula 1, 0<y≤0.5. It may be preferred that y is greater than or equal to 0.01, 0.02 or 0.03. It may be preferred that y is less than or equal to 0.4, 0.3, 0.2, 0.15, 0.1 or 0.05. It may also be preferred that 0.01≤y≤0.5, 0.02≤y≤0.5, 0.03≤y≤0.5, 0.01≤y≤0.4, 0.01≤y≤0.3, 0.01≤y≤0.2, 0.01≤y≤0.01 or 0.03≤y≤0.1.

A is one or more of Al, V, Ti, B, Zr, Cu, Sn, Cr, Fe, Ga, Si, Zn, Mg, Sr, and Ca. Preferably, A is at least Mg and/or Al, or A is Al and/or Mg. Where A comprises more than one element, z is the sum of the amount of each of the elements making up A.

In Formula I, 0≤z≤0.2. It may be preferred that 0≤z≤0.15, 0 ≤z≤0.10, 0 ≤z≤0.05, 00.05, 0≤z≤0.04, 0≤z≤0.03, or 0≤z≤0.02. In some embodiments, z is 0.

In Formula I, −0.2≤b≤0.2. It may be preferred that b is greater than or equal to -0.1. It may also be preferred that b is less than or equal to 0.1. It may be further preferred that -0.1 b 0.1. In some embodiments, b is 0 or about 0.

Typically, the surface-modified particulate lithium nickel metal oxide material is a crystalline (or substantially crystalline material). It may have the α-NaFeO₂-type structure.

The surface-modified lithium nickel metal oxide particles are in the form of secondary particles which comprise a plurality of primary particles (made up from one or more crystallites). The primary particles may also be known as crystal grains. The primary particles are separated by grain boundaries.

The particulate lithium nickel metal oxide material of Formula I is surface-modified. Herein, the term “surface-modified” refers to a particulate material which comprises primary and/or secondary particles which have undergone a surface modification process to increase the concentration of at least one element near to the surface of the particles, i.e. that the particles comprise a layer of material at or near to the surface of the particles which contains a greater concentration of at least one element than the remaining material of the particle, i.e. the core of the particle. The surface modification results from contacting the particles with one or more further metal-containing compounds, and then heating the material. For clarity, the discussions of the composition according to Formula I herein, when in the context of surface-modified particles, relate to the overall particle, i.e. the particle including the modified surface layer.

The particulate lithium nickel metal oxide material of Formula I may comprise enriched grain boundaries, i.e. that the concentration of one or more metals at the grain boundaries is greater than the concentration of the one or more metals in the primary particles. The grain boundaries may be enriched with, for example, cobalt and/or aluminium.

It may be preferred that M includes cobalt and that the concentration of cobalt at the grain boundaries between the primary particles is greater than the concentration of cobalt in the primary particles. Alternatively, or in addition, it may be further preferred that the concentration of aluminium at the grain boundaries between the primary particles is greater than the concentration of aluminium in the primary particles.

The concentration of cobalt in the primary particles may be at least 0.5 atom %, e.g. at least 1 atom %, at least 2 atom % or at least 2.5 atom % with respect to the total content of Ni, M and A in the primary particle. The concentration of cobalt in the primary particle may be 35 atom % or less, e.g. 30 atom % or less, 20 atom % or less, 15 atom % or less, 10 atom % or less, 8 atom % or less or 5 atom % or less with respect to the total content of Ni, M and A in the primary particles.

The concentration of cobalt at the grain boundaries may be at least 1 atom %, at least 2 atom %, at least 2.5 atom % or at least 3 atom % with respect to the total content of Ni, M, and A at the grain boundaries. The concentration of cobalt at the grain boundaries may be 40 atom % or less, e.g. 35 atom % or less, 30 atom % or less, 20 atom % or less, 15 atom % or less, 10 atom % or less, or 8 atom % or less with respect to the total content of Ni, M and A in the primary particles.

The difference between the concentration of cobalt in the primary particles and at the grain boundaries may at least 1 atom %, e.g. at least 3 atom % or at least 5 atom % (calculated by subtracting the concentration of cobalt in the primary particles in atom % from the concentration of cobalt at the grain boundaries in atom %).

The concentration of a metal, such as cobalt or aluminium, at the grain boundaries and in the primary particles may be determined by energy dispersive X-ray (EDX) analysis of the centre of a grain boundary and the centre of an adjacent primary particle for a thinly sliced (e.g. 100-150 nm thick) section of a particle by a sectioning technique such as focused ion beam milling.

The particles of surface-modified lithium nickel metal oxide may have a cobalt-rich coating on their surface. The concentration of cobalt in the secondary particles may decrease in a direction from the surface of the secondary particles to the centre of the secondary particles. The difference between the concentration of cobalt at the surface of the secondary particles and in the centre of the secondary particles may be at least 1 atom %, e.g. at least 3 atom % or at least 5 atom % (calculated by subtracting the concentration of cobalt at the surface of the particles in atom % from the concentration of cobalt at the centre of the particles in atom %). The concentration of cobalt may be determined as defined above for the grain boundaries and primary particles.

Alternatively, or in addition, the particles of surface-modified lithium nickel metal oxide may have an aluminium-rich coating on their surface. The concentration of aluminium in the secondary particles may decrease in a direction from the surface of the secondary particles to the centre of the secondary particles. The difference between the concentration of aluminium at the surface of the secondary particles and in the centre of the secondary particles may at least 1 atom %, e.g. at least 3 atom % or at least 5 atom % (calculated by subtracting the concentration of aluminium at the surface of the particles in atom % from the concentration of aluminium at the centre of the particles in atom %). The concentration of aluminium may be determined as defined above for the level of cobalt at the grain boundaries and primary particles.

The particles of surface-modified lithium nickel metal oxide typically have a volumetric D50 particle size of at least 1μm, e.g. at least 2μm, at least 4μm or at least 5μm. The particles of surface-modified lithium nickel metal oxide (e.g. secondary particles) typically have a D50 particle size of 30μm or less, e.g. 20μm or less or 15μm or less. It may be preferred that the particles of surface-modified lithium nickel metal oxide have a D50 of 1μm to 30μm, such as between 2μm and 20μm, or 5μm and 15μm. The D50 particle size may be determined by using a laser diffraction method (e.g. by suspending the particles in water and analysing using a Malvern Mastersizer 2000).

The process as described herein comprises the addition of a coating liquid to lithium nickel metal oxide particles.

The lithium nickel metal oxide particles are provided in the form of secondary particles comprising a plurality of primary particles. The particles prior to the addition of the coating liquid may be known as the ‘base material’. In some embodiments the particles of the base material have a composition according to Formula (II)

Liₐ₁Niₓ₁M_{y1}A_{z1}O_{2+b1} Formula II
in which:
M is one or more of Co and Mn;
A is one or more of Al, V, Ti, B, Zr, Cu, Sn, Cr, Fe, Ga, Si, Zn, Mg, Sr, and Ca
0.8≤a1≤1.2
0.5≤x1<1
0<y1≤0.5
0≤z1≤0.2
−0.2≤b1≤0.2
x+y+z=1

It may be preferred that A in Formula II is not Al. In such cases A is one or more of V, Ti, B, Zr, Cu, Sn, Cr, Fe, Ga, Si, Zn, Mg, Sr, and Ca. It may also be preferred that M in Formula II is Co alone, i.e. that the base material contains no Mn.

It will be understood by the skilled person that the values a1, x1,y1,z1 and b1, and the element(s) A, are selected so as to achieve the desired composition of Formula 1 after the process as described herein.

The base materials are produced by methods well known to the person skilled in the art. These methods involve the co-precipitation of a mixed metal hydroxide from a solution of metal salts, such as metal sulfates, for example in the presence of ammonia and a base, such as NaOH. In some cases, suitable mixed metal hydroxides may be obtainable from commercial suppliers known to the skilled person. The mixed metal hydroxides are then mixed with a lithium-containing compound, such as lithium hydroxide or lithium carbonate, and hydrated forms thereof, prior to a calcination step to form the base material.

The coating liquid comprises at least one metal-containing compound. It will be understood by the skilled person that the coating liquid comprises those elements which are desired to be present in the surface layer of the surface-modified particulate lithium nickel metal oxide material. The metal-containing compounds are typically metal salts, such as nitrates, sulfates, citrates or acetates. It may be preferred that the metal containing compounds are inorganic metal salts. Nitrates may be particularly preferred.

Preferably, the coating liquid comprises an aluminium-containing compound. The aluminium-containing compound is typically an aluminium salt, such as an inorganic aluminium salt, for example aluminium nitrate. The use of an aluminium-containing compound in the coating liquid can lead to an increase in the concentration of aluminium at the grain boundaries and/or at or near to the surface of the surface-modified lithium nickel metal oxide particles.

Alternatively, or in addition, it is preferred that the coating liquid comprises a cobalt-containing compound. The cobalt-containing compound is typically a cobalt salt, such as an inorganic cobalt salt, for example cobalt nitrate. The use of a cobalt-containing compound in the coating liquid can lead to an increase in the concentration of cobalt at the grain boundaries and/or at or near to the surface of the surface-modified lithium nickel metal oxide particles.

Optionally, the coating liquid comprises a lithium-containing compound. It proposed that this may be beneficial in order to avoid voids or defects in the structure of the surface-modified particulate lithium nickel metal oxide material which may lead to a reduced lifetime.

It may be preferred that the one or more metal-containing compound(s) are provided as hydrates of metal salts, for example a hydrate of a metal nitrate, such as a hydrate of cobalt nitrate and/or aluminium nitrate, optionally in combination with lithium nitrate, or a hydrate of lithium nitrate

It may be particularly preferred that the one or more metal salt hydrates are heated to form the coating liquid. Advantageously, such materials dehydrate upon heating leading to a phase change and formation of a liquid suitable for coating with a high metal concentration. Furthermore, metal salt hydrates are typically more economical than de-hydrated equivalents. Optionally, and if required, further water may be added to achieve the required volume of coating liquid.

The coating liquid is provided at a temperature of at least 50° C. This reduces the likelihood of crystallisation of the one or more metal-containing compound(s) during addition which would lead to poor mixing and an inhomogeneous coating. Furthermore, the use of an elevated temperature allows for the use of metal salts at high concentration and for the coating liquid to be prepared by heating metal salt hydrates.

Typically, the coating liquid is provided at a temperature of from 50 to 80° C., such as from 50 to 75° C., 55 to 75° C., 60 to 75° C., or 6 to 75° C.

Typically, the total molar concentration of metal in the coating liquid (i.e. the sum of the molar concentration of each metal in the coating liquid) is at least 0.5 mol/L. The skilled person will understand that the total metal concentration of the coating liquid used will depend on the amount of metal that is required to be applied to the base material and also the apparent pore volume of the base material. However, total metal concentrations less than 0.5 mol/L may not provide a consistent coating of the base material and/or grain boundary enrichment. Preferably, the total molar concentration of metal in the coating liquid is at least 0.75 mol/L, 1.0 mol/L, 1.25 mol/L, 1.5 mol/L, 1.75 mol/L, 2.0 mol/L, 2.5 mol/L or 3 mol/L.

The skilled person will understand that the total molar concentration will be limited by the solubility of the metal-containing compounds in the required volume of coating liquid. Typically, the total molar concentration of metal in the coating liquid is less than 7 mol/L. Typically, the total molar concentration of metal in the coating liquid is from 0.5 mol/L to 7 mol/L, such as from 1 mol/L to 7 mol/L, 2 mol/L to 7 mol/L, 3 mol/L to 7 mol/L, or 4 mol/L to 7 mol/L.

The coating liquid is added to the lithium nickel metal oxide particles. Typically, the lithium nickel metal oxide particles are loaded into a mixing vessel prior to the addition of the coating liquid. Typically, the particles are mixed during the coating liquid addition, for example through stirring or agitation. This ensures an even distribution of the coating liquid.

It may be preferable that the addition step may be carried out under a controlled atmosphere, such as an atmosphere free of CO₂ and/or moisture, which may reduce the level of impurities, such as lithium carbonate, in the formed surface-modified lithium nickel metal oxide particles.

The addition may be carried out by a number of means, such as portionwise addition to a mixing vessel via an inlet pipe, or by spraying the coating liquid onto the lithium nickel metal oxide particles. It is considered that spraying the coating liquid may lead to a more consistent distribution of the coating liquid, a more reproduceable coating process, and a shorter mixing time following complete addition of the coating liquid.

The addition step may be carried out at an elevated temperature, i.e. the temperature at which the vessel containing the lithium nickel metal oxide particles is heated to is higher than ambient temperature prior to addition of the coating liquid, such as a temperature greater than 25° C., preferably greater than 30° C., or greater than 40° C. The use of an elevated temperature during the addition step reduces the likelihood of solidification or crystallisation of the components of the coating liquid during the addition step, therefore helping to ensure a homogenous coating.

It may be preferable to carry out the addition step at a temperature of from 40° C. to 80° C., such as from 50° C. to 70° C., or from 55° C. to 65° C. The use of such addition temperatures may lead to improved electrochemical performance of the surface-modified particulate lithium nickel metal oxide, for example an improved capacity retention.

In the process as described herein the coating liquid is added to the lithium nickel metal oxide particles in a volume corresponding to 50 to 150% of the apparent pore volume of the lithium nickel metal oxide particles. The use of a volume of coating liquid less than 50% of the apparent pore volume of the particles may lead to an inhomogeneous surface-modification. It has been found that the use of a volume of coating liquid greater than 150% of the apparent pore volume of the particles is not required in order to achieve surface-modification and grain boundary enrichment, and detrimentally leads to an increased need for solvent removal and/or drying and associated energy consumption.

Preferably, the coating liquid is added to the lithium nickel metal oxide particles in a volume corresponding to 70 to 150%, or more preferably 90 to 150%, of the apparent pore volume of the lithium nickel metal oxide particles. The use of a volume of coating liquid greater than 70%, or greater than 90% of the available pore volume, enables the use of use of higher amounts of the one or more metal-containing compound, which may lead to enhanced grain boundary enrichment.

Preferably, the coating liquid is added to the lithium nickel metal oxide particles in a volume corresponding to 70 to 125%, or more preferably 90 to 125% of the apparent pore volume of the lithium nickel metal oxide particles. Use of a volume of coating liquid less than 125% of the apparent pore volume leads to a lower requirement for drying and evaporation. It has also been observed that the use of a volume of coating liquid greater than 125% of the apparent pore volume of the particles can lead to pooling of the coating liquid in the vessel containing the lithium nickel metal oxide particles once the coating liquid has been added which may be detrimental to achieving a homogeneous surface-modification. It may be preferred that the volume of coating liquid added corresponds to 95% to 120% of the apparent pore volume of the particles, or 95% to 115%, or 95% to 110%, or 95% to 105%.

It may also be preferred that the volume of coating liquid added corresponds to 100% to 150% of the apparent pore volume of the particles, or 100 to 125%, 100 to 120%, 100 to 115% or 100 to 110 %.

The apparent pore volume per unit mass of base material is determined using a torque measurement system, such as a Brabender Adsorptometer “C”. This method involves the measurement of torque during a mixing process. Water is added to the lithium nickel metal oxide particles whilst mixing, leading to a torque peak on a volume added-torque curve. The volume of water added per unit mass of particles at the point of onset of the torque peak is the apparent pore volume per unit mass of particles.

Following complete addition of the coating liquid the particles may be mixed for a period of time. Typically, the particles may be mixed for a period of from 1 to 60 minutes following complete addition of the coating liquid. The impregnated particles are then optionally dried prior to a calcination step, for example by heating to a temperature of from 100 to 150° C., such as 120° C., for example for a period of time of from 1 to 5 hours, such as 2 hours. It may be preferred that, after complete addition of the coating liquid, the impregnated particles are subjected directly to the calcination step, without the requirement for additional drying. Advantageously, the impregnated particles may be transferred directly from the vessel used for the addition of the coating liquid to a calciner.

The impregnated particles are then subjected to a calcination step. The calcination step may be carried out at a temperature of at least 400° C., at least 500° C., at least 600° C. or at least 650° C. The calcination step may be carried out at a temperature of 1000° C. or less, 900° C. or less, 800° C. or less or 750° C. or less. The material to be heated may be at a temperature of 400° C., at least 500° C., at least 600° C. or at least 650° C. for a period of at least 30 minutes, at least 1 hour, or at least 2 hours. The period may be less than 6 hours. Preferably, the calcination step is carried out within the temperature range of from 400 to 1000° C. for a period of from 30 mins to 6 hours.

The calcination step may be carried out under a CO₂-free atmosphere. For example,

CO₂₋free air may be flowed over the materials during heating and optionally during cooling. The CO₂-free air may, for example, be a mix of oxygen and nitrogen. Preferably, the atmosphere is an oxidising atmosphere. As used herein, the term “CO₂-free” is intended to include atmospheres including less than 100 ppm CO₂, e.g. less than 50 ppm CO₂, less than 20 ppm CO₂ or less than 10 ppm CO₂. These CO₂ levels may be achieved by using a CO₂ scrubber to remove CO₂.

It may be preferred that the CO₂-free atmosphere comprises a mixture of O₂ and N₂. It may be further preferred that the mixture comprises a greater amount of N₂ than O₂. In some embodiments, the mixture comprises N₂ and O₂ in a ratio of from 50:50 to 90:10, for example from 60:40 to 90:10, for example about 80:20.

The process may include one or more milling steps, which may be carried out after the calcination step. The nature of the milling equipment is not particularly limited. For example, it may be a ball mill, a planetary ball mill or a rolling bed mill. The milling may be carried out until the particles reach the desired size. For example, the particles of the surface-modified lithium nickel metal oxide material may be milled until they have a volume particle size distribution such that the D50 particle size is at least 5 μm, e.g. at least 5.5 μm, at least 6 μm or at least 6.5 μm. The particles of surface-modified lithium nickel metal oxide material may be milled until they have a volume particle size distribution such that the D50 particle size is 15 μm or less, e.g. 14 μm or less or 13 μm or less.

The process of the present invention may further comprise the step of forming an electrode (typically a cathode) comprising the surface-modified lithium nickel metal oxide material. Typically, this is carried out by forming a slurry of the surface-modified lithium nickel metal oxide material, applying the slurry to the surface of a current collector (e.g. an aluminium current collector), and optionally processing (e.g. calendaring) to increase the density of the electrode. The slurry may comprise one or more of a solvent, a binder, carbon material and further additives.

Typically, the electrode of the present invention will have an electrode density of at least 2.5 g/cm³, at least 2.8 g/cm³ or at least 3 g/cm³. It may have an electrode density of 4.5 g/cm³ or less, or 4 g/cm³ or less. The electrode density is the electrode density (mass/volume) of the electrode, not including the current collector the electrode is formed on. It therefore includes contributions from the active material, any additives, any additional carbon material, and any remaining binder.

The process of the present invention may further comprise constructing a battery or electrochemical cell including the electrode comprising the surface-modified lithium nickel metal oxide material. The battery or cell typically further comprises an anode and an electrolyte. The battery or cell may typically be a secondary (rechargeable) lithium (e.g. lithium ion) battery.

The present invention will now be described with reference to the following examples, which are provided to assist with understanding the present invention and are not intended to limit its scope.

### EXAMPLES

### Example 1—Example Preparation of Lithium Nickel Metal Oxide Base Material

(Li_{1.03}Ni_{0.91}Co_{0.08}Mg_{0.01}O₂, Base Material A)

Ni_{0.91}Co_{0.08}Mg_{0.01}(OH)₂ (100 g, Brunp) and LiOH (26.3 g) were dry mixed in a poly-propylene bottle for 1 hour. The LiOH was pre-dried at 200° C. under vacuum for 24 hours and kept dry in a purged glovebox filled with dry N₂.

The powder mixture was loaded into 99%+ alumina crucibles and calcined under CO₂-free air. Calcination was performed as follows: to 450° C. (5° C./min) with 2 hours hold, ramp to 700° C. (2° C./min) with a 6 hour hold and cooled naturally to 130° C. The CO₂-free air was flowed over the powder bed throughout the calcination and cooling. The title compound was thereby obtained.

The samples were then removed from the furnace at 130° C. and transferred to a high-alumina lined mill pot and milled on a rolling bed mill until D₅₀ was between 9.5 and 10.5 μm.

### Example 2—Example Preparation of Lithium Nickel Metal Oxide Base Material

(Li_{1.03}Ni_{0.90}Co_{0.08}Mg_{0.02}O₂, Base Material B)

Ni_{0.90}CO_{0.08}Mg_{0.02}(OH)₂ (100 g, Brunp and LiOH (26.2 g) were dry mixed in a poly-propylene bottle for 1 hour. The LiOH was pre-dried at 200° C. under vacuum for 24 hours and kept dry in a purged glovebox filled with dry N₂. The mixture was then calcined and milled as for Example 1 to yield Base Material B.

### Example 3—Method of Producing a Surface-Modified Lithium Nickel Metal Oxide Material

(Li_{1.01}Ni_{0.867}Co_{0.115}Al_{0.006}Mg_{0.012}O₂)

(A) Calculation of the Apparent Pore Volume of the Base Material

92.7 g of a lithium nickel metal oxide base material of formula Li_{1.03}Ni_{0.91}Co_{0.08}Mg_{0.01}O₂ (Base Material A) was loaded into a Brabendar absorptometer B torque measurement system and demineralised water added at 4 ml/min. The torque readings were plotted against the amount of liquid added per mass of solid material. The torque readings showed a peak value at 0.14 ml/g. The onset of the torque increase leading to this peak was then taken as the apparent pore volume per unit mass of the lithium nickel metal oxide base material (0.12 ml/g).

(B) Calculation of Volume of Coating Liquid to be Used

(1) Based on a desired surface-modified lithium nickel metal oxide composition of Li_{1.01}Ni_{0.867}Co_{0.115}Al_{0.006}Mg_{0.012}O₂, the amounts of Co, Al and Li that were required to be added to a 500 g sample of lithium nickel metal oxide Base Material A were calculated (as set out below), and hence the amounts of the nitrate crystals to be used.

| | | | |
|---|---|---|---|
| Mass of base: | 500 g | | |
| Mass of cobalt | 11.96 g | Weight of Co(NO₃)₂•6H₂O: | 59.04 g |
| to be added: | | | |
| Mass of aluminium | 0.88 g | Weight of Al(NO₃)₂•9H₂O: | 12.18 g |
| to be added: | | | |
| Mass of lithium | 1.65 g | Weight LiNO₃: | 16.39 g |
| to be added: | | | |

(2) The volume of liquid obtained when the mixed nitrate crystals were heated to 60° C. was measured as 52 mL.

(3) The apparent pore volume of the lithium nickel metal oxide Base Material A (500 g) was calculated as 60 mL (0.12 mL/g*500 g).

(4) The amount of water to be added to the nitrate crystals to achieve a volume of coating liquid corresponding to approximately 120% of the apparent pore volume was calculated as 20 mL.

### (C) Preparation of Surface-Modified Lithium Nickel Metal Oxide Material

(Li_{1.01}Ni_{0.867}Co_{0.115}Al_{0.006}Mg_{0.012}O₂)

Cobalt (II) nitrate hexahydrate (59.0 g, ACS, 98-102%, from Alfa Aesar), aluminium nitrate nonahydrate (12.2 g, 98% from Alfa Aesar) and lithium nitrate (16.4 g, anhydrous, 99%, from Alfa Aesar) were combined with water (20 ml) and then heated to approximately 60° C. to form the coating liquid.

A sample of Base Material A (500 g) was loaded into a Winkworth Mixer model MZ05 and heated to 60° C. with the mixer running at 50 rpm. The coating liquid was then added to the base material using a pipette over a period of 5 minutes. The mixer was then left to run for 15 minutes before discharging the sample.

Approximately 250 g of the powder was added to an alumina crucible. The sample was then calcined in a Carbolite Gero GPC1200 furnace with CO₂ free air supplied from a scrubber.

The sample was calcined by heating at 5° C./min to 450° C., 1 hour hold at 450° C., heating at 2° C./min to 700° C., 2 hour hold at 700° C., cool to RT with 4 ml/min flow rate of CO₂ free air.

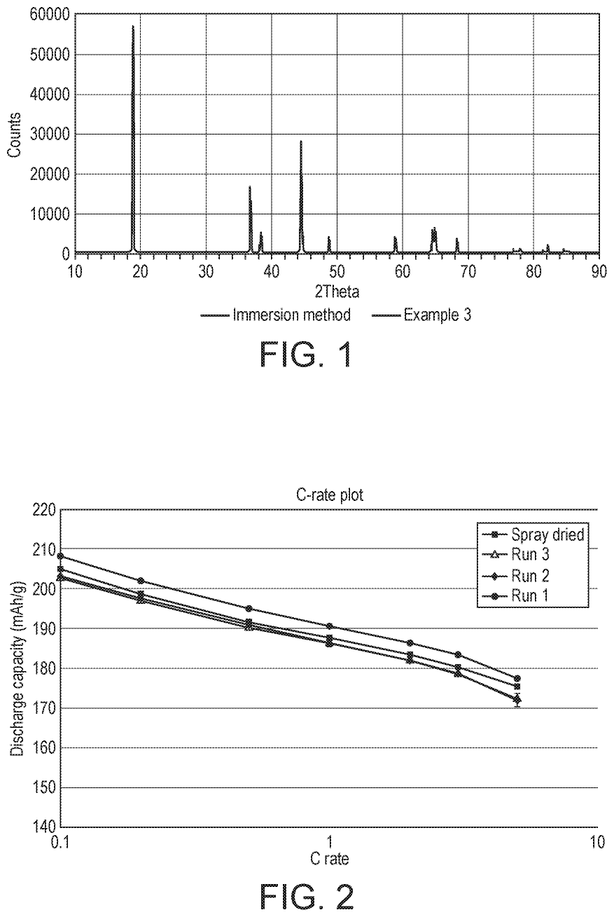

X-ray powder diffraction (XRD) of the material produced showed crystalline material with a layered α-NaFeO₂-type structure. The XRD pattern matched previous samples of the same composition produced by an immersion-spray drying method (FIG. 1).

### Example 4—Method of Poducing a Surface-Modified Lithium Nickel Metal Oxide Material

(Li_{1.01}Ni_{0.867}Co_{0.115}Al_{0.006}Mg_{0.012}O₂)

A surface-modified lithium nickel metal oxide material of formula Li_{1.01}Ni_{0.867}Co_{0.115}Al_{0.006}Mg_{0.012}O₂ was prepared from Base Material B using a method analogous to Example 3.

### Example 5—Investigation of Process Parameters

A series of experiments were carried out to investigate coating process parameters. Each sample was prepared using 500 g of base material and coated using the method as described in Example 3 or Example 4 with the following variations:

| | | Base | Mixing | Liquid |
|---|---|---|---|---|
| Experimental | Base | material | speed | addition |
| run no | Material | temp (° C.) | (rpm) | time (s) |
| 1 | B | 20 | 50 | 300 |
| 2 | B | 60 | 25 | 300 |
| 4 | A | 20 | 50 | 300 |
| 5 | A | 60 | 50 | 300 |

X-ray powder diffraction (XRD) of the materials produced showed that crystalline materials with a layered α-NaFeO₂-type structure were produced by each run.

### Example 6—Dry Coating of Base Material Using Nitrate Powders (Comparative Example)

A further run (Experimental run 3) was also carried out in order to compare the results with those produced by dry mixing. In this example, solid cobalt (II) nitrate hexahydrate, aluminium nitrate nonahydrate and lithium nitrate were added directly to Base Material B in the Winkworth Mixer model MZ05 mixer as a powder (without heating the nitrate crystals or the addition of water to the nitrate crystals). The amounts of base materials and metals salts used were the same as used in experimental runs 1 and 2 of Example 5. The base material temperature prior to addition of the coating liquid was 60° C. and the mixer speed was 50 rpm. Subsequent heat treatment was as described for Example 2.

### Example 7—Method of Producing a Surface-Modified NMC Material

(Li_{1.01}Ni_{0.82}Co_{0.15}Mn_{0.07}Al_{0.008}O₂)

Approximately 90 g of an lithium nickel manganese cobalt oxide (NMC) base material of formula (Li_{1.0}Ni_{0.8}Mn_{0.1}Co_{0.1}O₂) was loaded into a Brabendar absorptometer B torque measurement system and demineralised water added at 4 ml/min. The torque readings were plotted against the amount of liquid added per mass of solid material. The torque readings showed a peak value at 0.15 ml/g. The onset of the torque increase leading to this peak was then taken as the apparent pore volume per unit mass of the NMC base material (0.13 ml/g).

The amounts of Co, Al and Li that were required to be added to a 500 g sample of the NMC base material to form a surface-modified NMC material of formula

Li_{1.01}Ni_{0.82}Co_{0.15}Mn_{0.07}Al_{0.006}O₂ were calculated (as set out below), and hence the amounts of the nitrate crystals to be used.

| | | | |
|---|---|---|---|
| Mass of base: | 500 g | | |
| Mass of cobalt | 11.96 g | Weight of Co(NO₃)₂•6H₂O: | 59.04 g |
| to be added: | | | |
| Mass of aluminium | 0.88 g | Weight of Al(NO₃)₂•9H₂O: | 12.18 g |
| to be added: | | | |
| Mass of lithium | 1.65 g | Weight LiNO₃: | 16.39 g |
| to be added: | | | |

The volume of liquid obtained when the mixed nitrate crystals were heated to 60° C. was measured as 52 mL. The apparent pore volume of the NMC base material (500 g) was calculated as 65 mL (0.13 mL/g*500 g). The amount of water to be added to the nitrate crystals to achieve a volume of coating liquid corresponding to approximately 120% of the apparent pore volume was calculated as 20 mL.

### Preparation of a Surface-Modified a Surface-Modified NMC Material

Cobalt (II) nitrate hexahydrate (59.0 g, ACS, 98-102%, from Alfa Aesar), aluminium nitrate nonahydrate (12.2 g, 98% from Alfa Aesar) and lithium nitrate (16.4 g, anhydrous, 99%, from Alfa Aesar) were combined with water (20 ml) and then heated to approximately 60° C. to form the coating liquid. A sample of NMC base material (500 g) was loaded into a Winkworth Mixer model MZ05 and heated to 60° C. with the mixer running at 50 rpm. The coating liquid was then added to the base material using a pipette over a period of 5 minutes. The mixer was then left to run for 15 minutes before discharging the sample.

Approximately 250 g of the powder was added to an alumina crucible. The sample was then calcined in a Carbolite Gero GPC1200 furnace with CO₂ free air supplied from a scrubber. The sample was calcined by heating at 5° C./min to 450° C., 1 hour hold at 450° C., heating at 2° C./min to 700° C., 2 hour hold at 700° C., cool to room temperature with 4 ml/min flow rate of CO₂ free air.

### Example 8—Electrochemical Testing

The samples from Example 5 and 6 were electrochemically tested using the protocol set out below. The samples were compared to control samples of lithium nickel metal oxide materials prepared from Base Materials A and B using a solution immersion—spray drying method analogous to the method described in WO2013025328, and matching the compositions prepared in experimental runs 1 and 2 and from experimental runs 4 and 5.

The surface-modified sample prepared in Example 7 was also tested using the electrochemical protocol together with the NMC base material used as a starting material in Example 7.

### Electrochemical Protocol

The electrodes were prepared by blending 94% wt of the lithium nickel metal oxide active material, 3% wt of Super-C as conductive additive and 3% wt of polyvinylidene fluoride (PVDF) as binder in N-methyl-2-pyrrolidine (NMP) as solvent. The slurry was added onto a reservoir and a 125 μm doctor blade coating (Erichsen) was applied to aluminium foil. The electrode was dried at 120° C. for 1 hour before being pressed to achieve a density of 3.0 g/cm³. Typically, loadings of active is 9 mg/cm². The pressed electrode was cut into 14 mm disks and further dried at 120° C. under vacuum for 12 hours.

Electrochemical test was performed with a CR2025 coin-cell type, which was assembled in an argon filled glove box (MBraun). Lithium foil was used as an anode. A porous polypropylene membrane (Celgrad 2400) was used as a separator. 1M LiPF₆ in 1:1:1 mixture of ethylene carbonate (EC), dimethyl carbonate (DMC) and ethyl methyl carbonate (EMC) with 1% of vinyl carbonate (VC) was used as electrolyte.

The cells were tested on a MACCOR 4000 series and were charged and discharged at 0.1C (1C=200 mAh/g) between 3.0 and 4.3 V at 23° C.

The cells were tested on a MACCOR 4000 series using C-rate and retention tests. The C-rate test charged and discharged cells between 0.1 C and 5 C. The retention test was carried out at 1 C with samples charged and discharged over 50 cycles. Both tests were carried out at 23° C.

### Electrochemical Results

The results of the testing of electrochemical performance are shown in FIGS. 2 to 7.

FIG. 2 shows a C-rate plot of samples produced in experimental runs 1 and 2 of Example 5, the dry mixing comparative example experimental run 3 of Example 6, and a comparative spray dried example (all produced from Base Material B). This showed that materials produced by methods of the present invention (Run 1 and Run 2) were able to at least match the discharge capacity of material produced by immersion-spray drying and dry mixing methodologies.

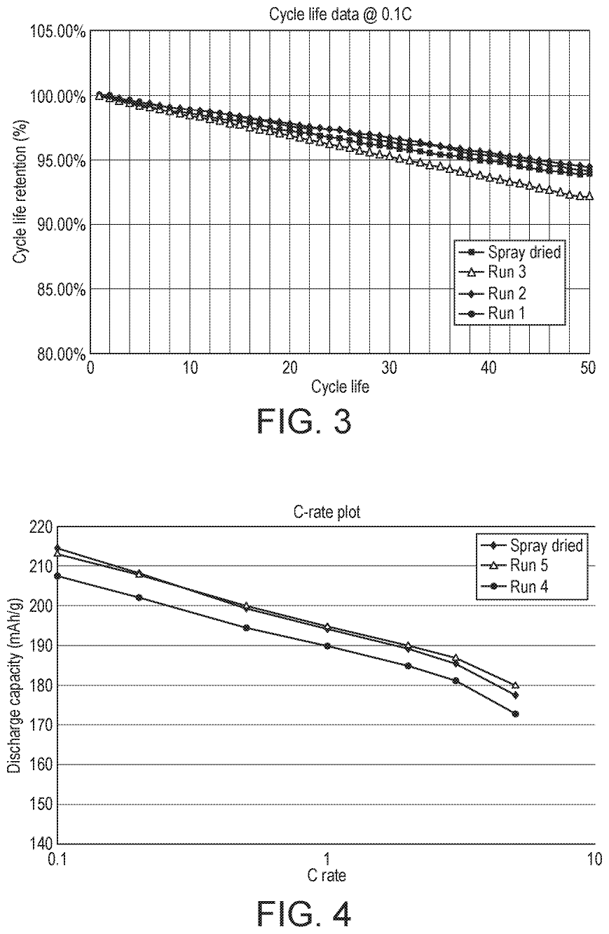

FIG. 3 shows the results of capacity retention testing of the samples produced in experimental runs 1 and 2 of Example 5, the dry mixing comparative example experimental run 3 of Example 6), and a comparative spray dried example (all produced from Base Material B). This indicates that the process of the invention provides materials which have a cycle life that matches that produced by the prior art immersion-spray dried method. The use of dry mixing provides a significantly reduced performance (experimental run 3) indicative of poor coating and/or a lack of grain boundary enrichment.

FIG. 4 shows a C-rate plot of samples produced in experimental runs 4 and 5 of Example 5 and a comparative spray dried example (all produced from Base Material A). This showed that materials produced by methods of the present invention (experimental run 4 and run 5) were able to match the discharge capacity of material produced by spray drying methodology. In this test the material produced with the base powder at an elevated temperature (60° C., experimental run 5) shows a higher discharge capacity with a base powder at ambient temperature (20° C., experimental run 4).

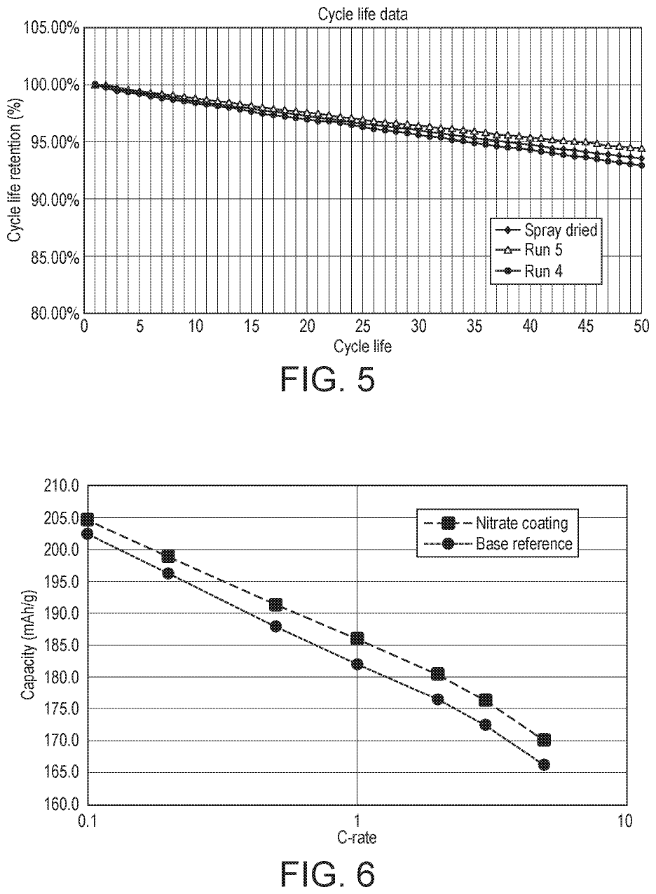

FIG. 5 shows the results of capacity retention testing of the samples produced in experimental runs 4 and 5 of Example 5 and a comparative spray dried example (all produced from Base Material A). This indicates that the process of the invention provides materials which have a cycle life that matches that produced by the prior art spray dried method. In this test, the material produced with the base powder at an elevated temperature (60° C., experimental run 5) shows improved cycle life retention to that produced with a base powder at ambient temperature (20° C., experimental run 4).

FIG. 6 shows C-rate plot from the electrochemical testing of the samples of the NMC base material and the surface-modified NMC material produced in Example 7. This shows that process as described herein leads to an improvement in discharge capacity across a range of discharge rates.

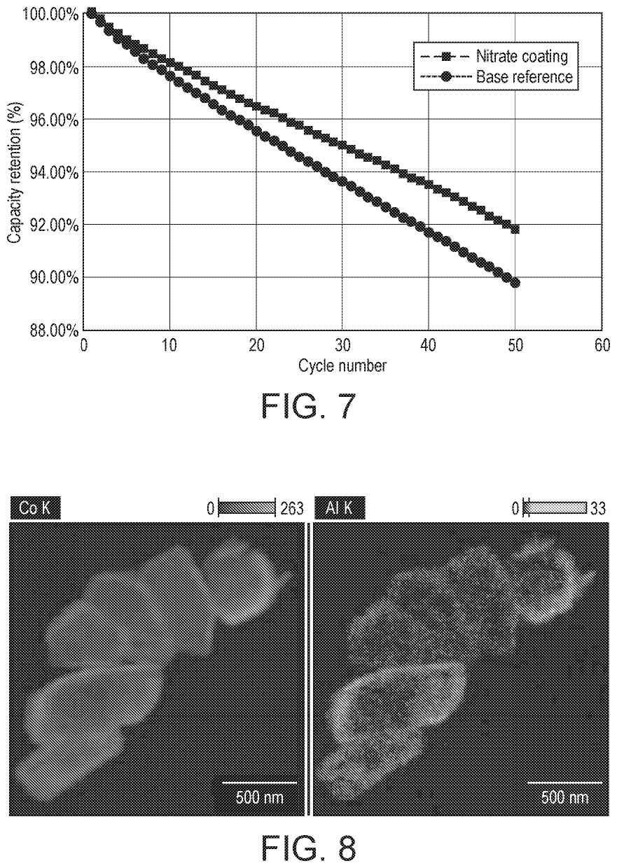

FIG. 7 shows the results of capacity retention testing of the samples of the NMC base material and the surface-modified NMC material produced in Example 7. This shows that process as described herein leads to an improvement in discharge capacity retention indicative of cobalt and aluminium concentration at the grain boundaries and at the surface of the NMC particles.

### Example 9—Analysis of Grain Boundary Enrichment

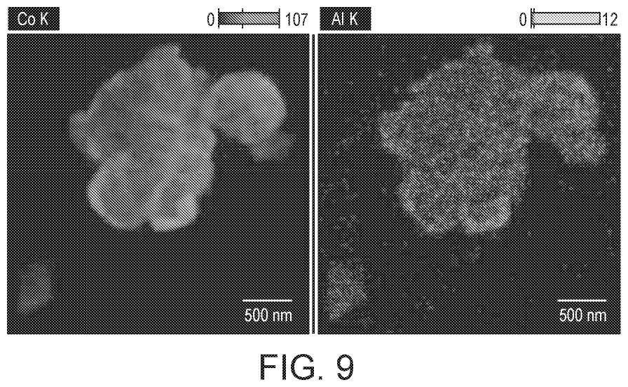

Samples prepared by a method analogous to experimental run 4 and run 5 of Example 5 were analysed by FIB-TEM (Focussed Ion Beam-Transmission Electron Microscopy) (experimental run 4—FIG. 8 and Run 5—FIG. 9). The images show that the grain boundaries between the primary particles, and the surface of the secondary particles, show cobalt and aluminium enrichment, with a higher cobalt and aluminium concentration at the grain boundaries and at the surface than is present in the primary particles.

1-18 canceled

19. A process for producing a surface-modified particulate lithium nickel metal oxide material having a composition according to Formula 1:
LiₐNiₓM_{y}A_{z}O₂+b Formula 1
in which:
M is one or more of Co and Mn;
A is one or more of Al, V, Ti, B, Zr, Cu, Sn, Cr, Fe, Ga, Si, Zn, Mg, Sr, and Ca
0.8≤a≤1.2
0.5≤x<1
0<y≤0.5
0≤z≤0.2
−0.2≤b≤0.2
x+y+z=1
the process comprising the steps of:
(i) providing lithium nickel metal oxide particles in the form of secondary particles comprising a plurality of primary particles;
(ii) providing a coating liquid at a temperature of at least 50° C., the coating liquid comprising at least one metal-containing compound;
(iii) adding the coating liquid to the lithium nickel metal oxide particles to form an impregnated powder, the volume of coating liquid added corresponding to 50 to 150% of the apparent pore volume of the lithium nickel metal oxide particles;
(iv) calcining the impregnated powder to form the surface-modified particulate lithium nickel metal oxide material.

20. The process according to claim 19 wherein A is Al and/or Mg.

21. The process according to claim 19 wherein M includes Co and the coating liquid comprises a cobalt-containing compound, preferably cobalt nitrate.

22. The process according to claim 21 wherein the concentration of cobalt at the grain boundaries of the surface-modified particulate lithium nickel metal oxide is greater than the concentration of cobalt in the primary particles of the surface-modified particulate lithium nickel metal oxide.

23. The process according to claim 19 wherein A includes Al and the coating liquid comprises an aluminium-containing compound, preferably aluminium nitrate.

24. The process according to claim 23 wherein the concentration of aluminium at the grain boundaries of the surface-modified particulate lithium nickel metal oxide is greater than the concentration of aluminium in the primary particles of the surface-modified particulate lithium nickel metal oxide.

25. The process according to claim 21 wherein the coating liquid comprises a lithium-containing compound, preferably lithium nitrate.

26. The process according to claim 19 wherein M is Co.

27. The process according to claim 19 wherein the coating liquid is provided at a temperature from 50 to 80° C.

28. The process according to claim 19 wherein the addition step is carried out at temperature from 40 to 80° C.

29. The process according to claim 19 wherein the coating liquid is formed by heating at least one hydrated metal salt.

30. The process according to claim 19 wherein the total molar concentration of metal in the coating liquid is at least 0.5 mol/L, at least 0.75 mol/L, at least 1 mol/L, at least 1.25 mol/L, at least 1.5 mol/L, at least 1.75 mol/L or at least 2 mol/L.

31. The process according to claim 19 wherein the coating liquid is added to the lithium nickel metal oxide particles by spraying the coating liquid onto the particles.

32. The process according to claim 19 wherein the calcination step is carried out at a temperature from 400 to 1000° C.

33. The process according to claim 19 wherein the volume of coating liquid added corresponds to 70 to 150% of the apparent pore volume of the lithium nickel metal oxide particles, preferably 90 to 150% or 90 to 125% of the apparent pore volume of the lithium nickel metal oxide particles.

34. The process according to claim 19 wherein the volume of coating liquid added corresponds to 100 to 150% of the apparent pore volume of the lithium nickel metal oxide particles, preferably 100 to 125% of the apparent pore volume of the lithium nickel metal oxide particles.

35. The process according to claim 19 further comprising the step of forming an electrode comprising the surface-modified lithium nickel metal oxide material.

36. The process according to claim 35 further comprising the step of constructing a battery or electrochemical cell including the electrode comprising the surface-modified lithium nickel metal oxide material.
